(19) United States
(12) Patent Application Publication
(10) Pub. No.: US 2022/0401825 A1
(43) Pub. Date: Dec. 22, 2022

(54) ALARM METHOD AND APPARATUS FOR TABLETOP GAME, ELECTRONIC DEVICE AND STORAGE MEDIUM

(71) Applicant: SENSETIME INTERNATIONAL PTE. LTD., Singapore (SG)

(72) Inventors: Xinxin WANG, Singapore (SG); Shuai Zhang, Singapore (SG); Kaiyun Wang, Singapore (SG)

(21) Appl. No.: 17/363,118

(22) Filed: Jun. 30, 2021

Related U.S. Application Data
(63) Continuation of application No. PCT/IB2021/055684, filed on Jun. 25, 2021.

(30) Foreign Application Priority Data
Jun. 21, 2021 (SG) 10202106722W

(51) Int. Cl. A63F 11/00; G08B 21/18; G06T 7/73; G06K 9/00

(52) U.S. Cl. CPC A63F 11/0074; G08B 21/182; G06T 7/73; G06K 9/00718; A63F 2011/0086; A63F 1/06

(57) ABSTRACT

Provided are an alarm method and apparatus for a tabletop game, an electronic device and a storage medium. The method includes that: at least one frame of game tabletop image collected in a prop operation stage of a game is acquired; for each frame, a placement position of a preset identity object in the game tabletop image is detected, a tabletop of the game including a placement region corresponding to each game party, and the preset identity object being configured to identify a first game party allowed to operate a game prop; a second game party corresponding to the placement position of the preset identity object is determined according to the placement region corresponding to each game party; and in a case where the first game party is inconsistent with the second game party, alarm information for characterizing a placement error of the preset identity object is output.

### CROSS-REFERENCE TO RELATED APPLICATION

This is continuation application of international application PCT/IB2021/055684, filed on 25 Jun. 2021, which claims priority to Singaporean patent application No. 10202106722W, filed with IPOS on 21 Jun. 2021. The contents of international application PCT/IB2021/055684 and Singaporean patent application No. 10202106722W are incorporated herein by reference in their entireties.

### TECHNICAL FIELD

The disclosure relates to the technical field of computer visions, and more particularly, to an alarm method and apparatus for a tabletop game, an electronic device and a storage medium.

### BACKGROUND

At present, concerning some special activity scenarios, for example, in game scenarios, corresponding game rules are typically provided, and must be followed by operations of game participators during gaming.

However, due to possible subjective reasons such as misunderstandings, tensions and exhaustions of people, the operations in the activity scenarios fail to follow the corresponding rules, and a special article has a placement error, to make activities abnormal. There is a need to monitor such a situation.

### SUMMARY

The embodiments of the disclosure are intended to provide an alarm method and apparatus for a tabletop game, an electronic device and a storage medium.

The technical solutions in the embodiments of the disclosure are implemented as follows.

The embodiments of the disclosure provide an alarm method for a tabletop game, which may include the following operations.

At least one frame of game tabletop image collected in a prop operation stage of a game is acquired.

For each frame in the at least one frame of game tabletop image, a placement position of a preset identity object in the game tabletop image is detected, a tabletop of the game including a placement region corresponding to each game party in at least two game parties, and the preset identity object being configured to identify a first game party allowed to operate a game prop.

A second game party corresponding to the placement position of the preset identity object is determined according to the placement region corresponding to each game party.

In a case where the first game party is inconsistent with the second game party, alarm information for characterizing a placement error of the preset identity object is output.

In some embodiments, the operation that the second game party corresponding to the placement position of the preset identity object is determined according to the placement region corresponding to each game party may include the following operation.

In a case where the placement position is not within a first prop operation region, the second game party corresponding to the placement position of the preset identity object is determined according to the placement region corresponding to each game party.

The first prop operation region includes a region where a game controller operates a game prop.

In some embodiments, after the alarm information for characterizing the placement error of the preset identity object is output, the method may further include the following operation.

In a case where it is detected that the first game party is consistent with the second game party in an image after a first image in the at least one frame of game tabletop image, the alarm information for characterizing the placement error of the preset identity object is removed.

The first image is an image where it is detected that the first game party is inconsistent with the second game party in the at least one frame of game tabletop image.

In some embodiments, the method may further include the following operations.

In a case where the placement position is within the first prop operation region, a position of the game prop is detected based on the at least one frame of game tabletop image.

In response to that the position of the game prop is not within the first prop operation region, alarm information for characterizing an operation error of the game prop is output.

In some embodiments, after the alarm information for characterizing the operation error of the game prop is output, the method may further include the following operation.

In a case where it is detected that the position of the game prop is within the first prop operation region in an image after a second image in the at least one frame of game tabletop image, the alarm information for characterizing the operation error of the game prop is removed.

The second image is an image where it is detected that the position of the game prop is not within the first prop operation region in the at least one frame of game tabletop image.

In some embodiments, the first prop operation region may include at least two first sub-operation regions in one-to-one correspondence with the at least two game parties, and the method may further include the following operation.

In a case where a first sub-operation region where the placement position is located does not have the game prop, alarm information for characterizing an operation error of a game prop of a target game party is output, the target game party being a game party corresponding to the first sub-operation region where the placement position is located.

In some embodiments, after the alarm information for characterizing the operation error of the game prop of the target game party is output, the method may further include the following operation.

In a case where it is detected that the first sub-operation region where the placement position is located has the game prop in an image after a third image in the at least one frame of game tabletop image, the alarm information for characterizing the operation error of the game prop of the target game party is removed.

The third image is an image where it is detected that the first sub-operation region where the placement position is located does not have the game prop in the at least one frame of game tabletop image.

In some embodiments, the first prop operation region may include at least two first sub-operation regions in one-to-one correspondence with the at least two game parties, and the method may further include the following operations.

In a case where the placement position is within a second prop operation region, a position of the game prop is detected based on the at least one frame of game tabletop image, wherein the second prop operation region may include a region where the at least two game parties operate the game prop.

In a case where the position of the game prop is within a first sub-operation region corresponding to the first game party, a state of an identity face of the game prop is detected based on the at least one frame of game tabletop image.

In a case where the state of the identity face of the game prop is a readable state, alarm information for characterizing an operation error of the game prop is output.

In some embodiments, after the alarm information for characterizing the operation error of the game prop is output, the method may further include the following operation.

In a case where it is detected that the game prop is recycled in an image after a fourth image in the at least one frame of game tabletop image, the alarm information for characterizing the operation error of the game prop is removed.

The fourth image is an image where it is detected that the state of the identity face of the game prop is the readable state in the at least one frame of game tabletop image.

In some embodiments, the method may further include the following operation.

In a case where the position of the game prop is within the second game operation region, and the first game party is consistent with the second game party, a token in a placement region corresponding to the first game party is detected based on the at least one frame of game tabletop image.

In a case where the placement region corresponding to the first game party does not have the token, alarm information for characterizing that the token is not placed is output.

In some embodiments, after the alarm information for characterizing that the token is not placed is output, the method may further include the following operation.

In a case where it is detected that the placement region corresponding to the first game party has the token in an image after a fifth image in the at least one frame of game tabletop image, the alarm information for characterizing that the token is not placed is removed.

The fifth image is an image that the token is not detected in the placement region corresponding to the first game party in the at least one frame of game tabletop image.

In some embodiments, the method may further include the following operations.

A distance between the preset identity object and the game prop is detected based on the at least one frame of game tabletop image.

In a case where the distance exceeds a preset threshold, alarm information for characterizing that the game prop is not placed to a specified position is output.

In some embodiments, after the alarm information for characterizing that the game prop is not placed to the specified position is output, the method may further include the following operation.

In a case where it is detected that the distance does not exceed the preset threshold in an image after a sixth image in the at least one frame of game tabletop image, the alarm information for characterizing that the game prop is not placed to the specified position is removed.

The sixth image is an image where it is detected that the distance exceeds the preset threshold in the at least one frame of game tabletop image.

The embodiments of the disclosure provide an alarm apparatus for a tabletop game, which may include: an acquisition module, a detection module and an alarm module.

The acquisition module is configured to acquire at least one frame of game tabletop image collected in a prop operation stage of a game.

The detection module is configured to detect, for each frame in the at least one frame of game tabletop image, a placement position of a preset identity object in the game tabletop image, a tabletop of the game including a placement region corresponding to each game party in at least two game parties, and the preset identity object being configured to identify a first game party allowed to operate a game prop; and determine a second game party corresponding to the placement position of the preset identity object according to the placement region corresponding to each game party.

The alarm module is configured to output, in a case where the first game party is inconsistent with the second game party, alarm information for characterizing a placement error of the preset identity object.

In some embodiments, the detection module is specifically configured to determine, in a case where the placement position is not within a first prop operation region, the second game party corresponding to the placement position of the preset identity object according to the placement region corresponding to each game party, wherein the first prop operation region may include a region where a game controller operates a game prop.

In some embodiments, the alarm module is further configured to remove, in a case where the detection module detects that the first game party is consistent with the second game party in an image after a first image in the at least one frame of game tabletop image, the alarm information for characterizing the placement error of the preset identity object.

The first image is an image where it is detected that the first game party is inconsistent with the second game party in the at least one frame of game tabletop image.

In some embodiments, the detection module is further configured to detect, in a case where the placement position is within the first prop operation region, a position of the game prop based on the at least one frame of game tabletop image.

The alarm module is further configured to output, in response to that the position of the game prop is not within the first prop operation region, alarm information for characterizing an operation error of the game prop.

In some embodiments, the alarm module is further configured to remove, in a case where the detection module detects that the position of the game prop is within the first prop operation region in an image after a second image in the at least one frame of game tabletop image, the alarm information for characterizing the operation error of the game prop.

The second image is an image where it is detected that the position of the game prop is not within the first prop operation region in the at least one frame of game tabletop image.

In some embodiments, the first prop operation region may include at least two first sub-operation regions in one-to-one correspondence with the at least two game parties, and the method may further include the following operation.

The alarm module is further configured to output, in a case where a first sub-operation region where the placement position is located does not have the game prop, alarm information for characterizing an operation error of a game prop of a target game party, the target game party being a game party corresponding to the first sub-operation region where the placement position is located.

In some embodiments, the alarm module is further configured to remove, in a case where the detection module detects that the first sub-operation region where the placement position is located has the game prop in an image after a third image in the at least one frame of game tabletop image, the alarm information for characterizing the operation error of the game prop of the target game party.

The third image is an image where it is detected that the first sub-operation region where the placement position is located does not have the game prop in the at least one frame of game tabletop image.

In some embodiments, the detection module is further configured to detect, in a case where the placement position is within a second prop operation region, a position of the game prop based on the at least one frame of game tabletop image, wherein the second prop operation region may include a region where the at least two game parties operate the game prop; and detect, in a case where the position of the game prop is within a first sub-operation region corresponding to the first game party in the first prop operation region, a state of an identity face of the game prop based on the at least one frame of game tabletop image.

The alarm module is further configured to output, in a case where the state of the identity face of the game prop is a readable state, alarm information for characterizing an operation error of the game prop.

In some embodiments, the alarm module is further configured to remove, in a case where the detection module detects that the game prop is recycled in an image after a fourth image in the at least one frame of game tabletop image, the alarm information for characterizing the operation error of the game prop.

The fourth image is an image where it is detected that the state of the identity face of the game prop is the readable state in the at least one frame of game tabletop image.

In some embodiments, the detection module is further configured to detect, in a case where the position of the game prop is within the second game operation region, and the first game party is consistent with the second game party, a token in a placement region corresponding to the first game party based on the at least one frame of game tabletop image.

The alarm module is further configured to output, in a case where the placement region corresponding to the first game party does not have the token, alarm information for characterizing that the token is not placed.

In some embodiments, the alarm module is further configured to remove, in a case where the detection module detects that the placement region corresponding to the first game party has the token in an image after a fifth image in the at least one frame of game tabletop image, the alarm information for characterizing that the token is not placed.

The fifth image is an image that the token is not detected in the placement region corresponding to the first game party in the at least one frame of game tabletop image.

In some embodiments, the detection module is further configured to detect a distance between the preset identity object and the game prop based on the at least one frame of game tabletop image.

The alarm module is further configured to output, in a case where the distance exceeds a preset threshold, alarm information for characterizing that the game prop is not placed to a specified position.

In some embodiments, the alarm module is further configured to remove, in a case where the detection module detects that the distance does not exceed the preset threshold in an image after a sixth image in the at least one frame of game tabletop image, the alarm information for characterizing that the game prop is not placed to the specified position.

The sixth image is an image where it is detected that the distance exceeds the preset threshold in the at least one frame of game tabletop image.

The embodiments of the disclosure provide an electronic device, which may include: a processor, a memory and a communication bus.

The communication bus is configured to implement connection and communication between the processor and the memory.

The processor is configured to execute one or more programs stored in the memory, to implement the alarm method for the tabletop game.

The embodiments of the disclosure provide a computer-readable storage medium, which stores one or more programs; and the one or more programs may be executed by one or more processors, to implement the alarm method for the tabletop game.

The disclosure provides the alarm method and apparatus for the tabletop game, the electronic device and the storage medium. The method includes that: at least one frame of game tabletop image collected in a prop operation stage of a game is acquired; for each frame in the at least one frame of game tabletop image, a placement position of a preset identity object in the game tabletop image is detected, a tabletop of the game including a placement region corresponding to each game party in at least two game parties, and the preset identity object being configured to identify a first game party allowed to operate a game prop; a second game party corresponding to the placement position of the preset identity object is determined according to the placement region corresponding to each game party; and in a case where the first game party is inconsistent with the second game party, alarm information for characterizing a placement error of the preset identity object is output. According to the technical solutions provided by the embodiments of the disclosure, by detecting whether a special object in the tabletop game is placed correctly, and outputting alarm information timely in a case of a placement error, automatic monitoring on a placement problem of the special object in the game is implemented.

### BRIEF DESCRIPTION OF THE DRAWINGS

FIG. 1 illustrates a first flowchart schematic diagram of an alarm method for a tabletop game provided by an embodiment of the disclosure.

FIG. 2 illustrates a second flowchart schematic diagram of an alarm method for a tabletop game provided by an embodiment of the disclosure.

FIG. 3 illustrates a third flowchart schematic diagram of an alarm method for a tabletop game provided by an embodiment of the disclosure.

FIG. 4 illustrates a fourth flowchart schematic diagram of an alarm method for a tabletop game provided by an embodiment of the disclosure.

FIG. 5 illustrates a fifth flowchart schematic diagram of an alarm method for a tabletop game provided by an embodiment of the disclosure.

FIG. 6 illustrates a structural schematic diagram of an alarm apparatus for a tabletop game provided by an embodiment of the disclosure.

FIG. 7 illustrates a structural schematic diagram of an electronic device provided by an embodiment of the disclosure.

### DETAILED DESCRIPTION

A clear and complete description on the technical solutions in the embodiments of the disclosure will be given below, in combination with the accompanying drawings in the embodiments of the disclosure.

The embodiments of the disclosure provide an alarm method for a tabletop game. The execution main body may be an alarm apparatus for the tabletop game. For example, the alarm method may be executed by a terminal device or a server or other electronic devices. The terminal device may be User Equipment (UE), a mobile device, a user terminal, a terminal, a cell phone, a cordless phone, a Personal Digital Assistant (PDA), a handheld device, a computing device, a vehicle-mounted device, a wearable device, etc. In some possible implementation modes, the alarm method may be implemented by enabling a processor to call a computer-readable instruction stored in a memory.

FIG. 1 illustrates a first flowchart schematic diagram of an alarm method for a tabletop game provided by an embodiment of the disclosure. As shown in FIG. 1, the alarm method for the tabletop game may mainly include the following steps.

In S101, at least one frame of game tabletop image collected in a prop operation stage of a game is acquired.

In the embodiment of the disclosure, when the game is in the prop operation stage, the alarm apparatus may collect at least one frame of game tabletop image in this stage.

It is to be noted that, in the embodiment of the disclosure, the alarm apparatus may detect a stage where the game is located, and then acquire, in a case where the game is in the game operation stage, at least one frame of game tabletop image of the game.

Exemplarily, in the embodiment of the disclosure, as both a game preparation stage and a game start stage need an operation on the game prop in fact, each of the game preparation stage and the game start stage may serve as the prop operation stage, and in a case where the game is in the game preparation stage and the game start stage, at least one frame of game tabletop image is collected.

It is to be noted that, in the embodiment of the disclosure, the alarm apparatus may include a camera module, and the alarm apparatus is deployed around the game scenario, thereby collecting the at least one frame of game tabletop image through the camera module in the prop operation stage of the game. In addition, the at least one frame of game tabletop image in the prop operation stage of the game may also be collected by an independent camera deployed around the game scenario, and transmitted to the alarm apparatus. The specific mode for acquiring the at least one frame of game tabletop image may be determined according to an actual demand and an apparatus configuration, and is not limited by the embodiment of the disclosure.

In S102, for each frame in the at least one frame of game tabletop image, a placement position of a preset identity object in the game tabletop image is detected, a tabletop of the game including a placement region corresponding to each game party in at least two game parties, and the preset identity object being configured to identify a first game party allowed to operate a game prop.

In the embodiment of the disclosure, after acquiring the at least one frame of game tabletop image in the prop operation stage of the game, the alarm apparatus may detect, for each frame of game tabletop image, the placement position of the preset identity object therein.

It is to be noted that, in the embodiment of the disclosure, the tabletop of the game is divided into at least two placement regions in one-to-one correspondence with the at least two game parties; and each placement region is associated with a corresponding game party, and configured to place a prop of the corresponding game party. The specific number of game parties included on the tabletop of the game and the position of the placement region corresponding to each game party may be set according to an actual demand and the game, and are not limited in the embodiment of the disclosure.

It is to be noted that, in the embodiment of the disclosure, the first game party in the game may operate the game prop, and the preset identity object is configured to identify the first game party allowed to operate the game prop. The specific preset identity object may be an object labeled with a special tag, and is not limited in the embodiment of the disclosure.

It is to be understood that, in the embodiment of the disclosure, the alarm apparatus may respectively detect the placement position of the preset identity object in each frame of the at least one frame of game tabletop image, and the preset identity object may be placed into the placement region corresponding to any game party in the at least two game parties.

In S103, a second game party corresponding to the placement position of the preset identity object is determined according to the placement region corresponding to each game party.

In the embodiment of the disclosure, after detecting the placement position of the preset identity object for each frame of game tabletop image, the alarm apparatus may determine the second game party corresponding to the placement position of the preset identity object according to the placement region corresponding to each game party.

Specifically, in the embodiment of the disclosure, the alarm apparatus determines the second game party corresponding to the placement position of the preset identity object according to the placement region corresponding to each game party, which may include that: in a case where the placement position is not within a first prop operation region, the second game party corresponding to the placement position of the preset identity object is determined according to the placement region corresponding to each game party. The first prop operation region may include a region where a game controller operates a game prop.

It is to be noted that, in the embodiment of the disclosure, the alarm apparatus determines the second game party corresponding to the placement position of the preset identity object, provided that the placement position of the preset identity object is not within the region where the game controller operates the game prop, i.e., within the first prop operation region.

It is to be noted that, in the embodiment of the disclosure, as the tabletop of the game includes the placement region corresponding to each game party, the alarm apparatus may determine a placement region to which the placement region belongs after detecting the placement position of the preset identity object, thereby further determining a game party corresponding to the placement region to which the placement region belongs as the second game party.

In S104, in a case where the first game party is inconsistent with the second game party, alarm information for characterizing a placement error of the preset identity object is output.

In the embodiment of the disclosure, the alarm apparatus outputs, after determining the second game party corresponding to the placement position of the preset identity object, if the second game party is inconsistent with the first game party identified by the preset identity object, the alarm information for characterizing the placement error of the preset identity object.

Exemplarily, in the embodiment of the disclosure, the tabletop of the game may include a replacement region A corresponding to a game party A, and a replacement region corresponding to a game party B, and the preset identity object is configured to characterize the game party A allowed to operate the game prop. If the placement position of the preset identity object is within the placement region B, the game party corresponding to the placement position is the game party B, i.e., the preset identity object is placed wrongly in fact; and by this time, the alarm apparatus outputs the corresponding alarm information.

It is to be noted that, in the embodiment of the disclosure, the game party corresponding to the placement position of the preset identity object needs to be consistent with the characterized game party in the game. However, when the preset identity object is placed, the problem of a determination error may occur. Hence, after determining the second game party corresponding to the placement position of the preset identity object, the alarm apparatus may further compare the second game party with the first game party; and in case of a difference, it is indicated that the preset identity object is placed wrongly. Therefore, the alarm information for characterizing the placement error of the preset identity object may be output for prompting, and thus error corrections may be made timely.

It is to be noted that, in the embodiment of the disclosure, after outputting the alarm information for characterizing the placement error of the preset identity object, the alarm apparatus may further execute the following step: in a case where it is detected that the first game party is consistent with the second game party in an image after a first image in the at least one frame of game tabletop image, the alarm information for characterizing the placement error of the preset identity object is removed. The first image is an image where it is detected that the first game party is inconsistent with the second game party in the at least one frame of game tabletop image.

It is to be understood that, in the embodiment of the disclosure, in the at least one frame of game tabletop image, the frame image where the alarm apparatus detects that the first game party is inconsistent with the second game party is the first image. After the alarm apparatus outputs the alarm information for characterizing the placement error of the preset identity object, the game controller may know the placement error of the preset identity object, and correct the position of the preset identity object; and correspondingly, the alarm apparatus may detect that the first game party is consistent with the second game party in the image after the first image, and remove the alarm information.

Exemplarily, in tabletop card games, the game prop in the embodiment of the disclosure may be a card, and the game prop operation stage is a stage where the game controller deals the card. In some games, according to rules, in the dealing stage of the game controller, the game controller deals the card with a back upward, and expresses that when a “card squinting” marker of the player is pushed to a placement region (such as a token placement region) corresponding to the game party selected by some player or a subregion corresponding to the game party selected by some player in a dealing region, the player is allowed to perform “card squinting” on the dealt card corresponding to the selected game party, and may take up the card and read card information of the card and then put it back to the game tabletop. In this situation, if it is detected that the game controller pushes the marker indicating the first game party of “card squinting” but the marker is pushed to the placement region (such as the token placement region) corresponding to the second game party, an alarm is sent in a case where the first game party is different from the second game party.

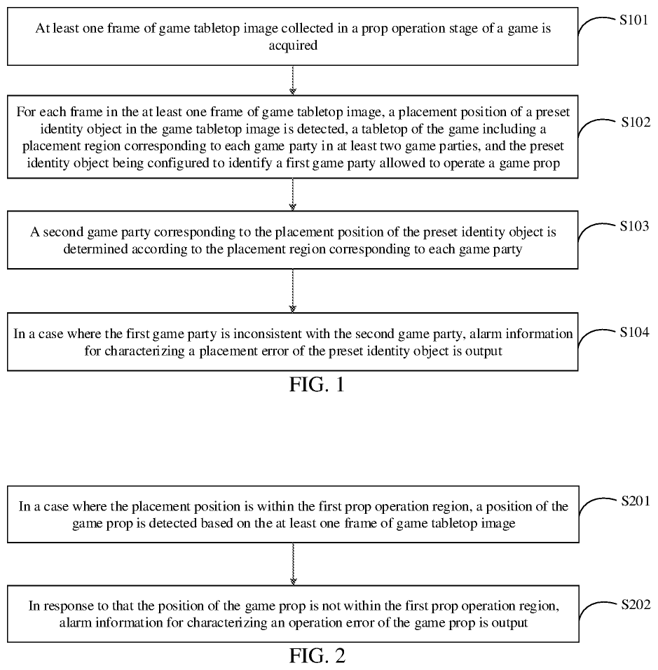

FIG. 2 illustrates a second flowchart schematic diagram of an alarm method for a tabletop game provided by an embodiment of the disclosure. As shown in FIG. 2, in the embodiment of the disclosure, as described in Step S103, the alarm apparatus determines the second game party in the case where the placement position of the preset identity object is not within the first prop operation region. In addition, the alarm apparatus may further execute the following steps.

In S201, in a case where the placement position is within the first prop operation region, a position of the game prop is detected based on the at least one frame of game tabletop image.

In S202, in response to that the position of the game prop is not within the first prop operation region, alarm information for characterizing an operation error of the game prop is output.

It is to be noted that, in the embodiment of the disclosure, the game further involves the game prop. In a case where the preset identity object is within the first prop operation region, the game prop also needs to be within the first prop operation region according to the game rules. By this time, if detecting that the game prop is not within the first prop operation region in the game tabletop image, the alarm apparatus characterizes the operation error of the game prop. Therefore, the alarm apparatus may output the alarm information for characterizing the operation error of the game prop, to prompt the game controller to make corrections, thereby improving the accuracy of placing the game prop in the tabletop game.

It is to be noted that, in the embodiment of the disclosure, after outputting the alarm information for characterizing the operation error of the game prop, the alarm apparatus may further execute the following step: in a case where it is detected that the position of the game prop is within the first prop operation region in an image after a second image in the at least one frame of game tabletop image, the alarm information for characterizing the operation error of the game prop is removed. The second image is an image where it is detected that the position of the game prop is not within the first prop operation region in the at least one frame of game tabletop image.

It is to be understood that, in the embodiment of the disclosure, in the at least one frame of game tabletop image, the image where the alarm apparatus detects that the game prop is not within the first prop operation region is the second image. After the alarm apparatus outputs the alarm information for characterizing the operation error of the game prop, the game controller may correct the operation on the game prop, and place the game prop within the first prop operation region; and correspondingly, the alarm apparatus may detect that the position of the game prop is within the first prop operation region in the image after the second image, and remove the alarm information.

In the embodiment of the disclosure, the first prop operation region may include at least two first sub-operation regions in one-to-one correspondence with the at least two game parties, and in a case where the placement position of the preset identity object is within the first operation region, the alarm apparatus may further execute the following step: in a case where a first sub-operation region where the placement position is located does not have the game prop, alarm information for characterizing an operation error of a game prop of a target game party is output, the target game party being a game party corresponding to the first sub-operation region where the placement position is located.

It is to be noted that, in the embodiment of the disclosure, the first prop operation region may include a first sub-operation region corresponding to each game party in the at least two game parties, and according to the game rules, if the preset identity object is within some first sub-operation region, the first sub-operation region further needs to have the game prop of the corresponding game party. Therefore, the alarm apparatus may detect whether the first sub-operation region where the preset identity object is placed has the game prop, and output the corresponding alarm information if the first sub-operation region does not have the game prop, to prompt the game controller to make corrections, thereby improving the accuracy of placing the game prop.

It is to be noted that, in the embodiment of the disclosure, after outputting the alarm information for characterizing the operation error of the game prop of the target game party, the alarm apparatus may further execute the following step: in a case where it is detected that the first sub-operation region where the placement position is located has the game prop in an image after a third image in the at least one frame of game tabletop image, the alarm information for characterizing the operation error of the game prop of the target game party is removed. The third image is an image where it is detected that the first sub-operation region where the placement position is located does not have the game prop in the at least one frame of game tabletop image.

It is to be understood that, in the embodiment of the disclosure, in the at least one frame of game tabletop image, the image where the alarm apparatus detects that the first sub-operation region where the placement position is located does not have the game prop is the third image. After the alarm apparatus outputs the alarm information for characterizing the operation error of the game prop of the target game party, the game controller may place the game prop within the first prop operation region where the placement position is located; and correspondingly, the alarm apparatus may detect that the first sub-operation region where the placement position is located has the game prop in the image after the third image and remove the alarm information.

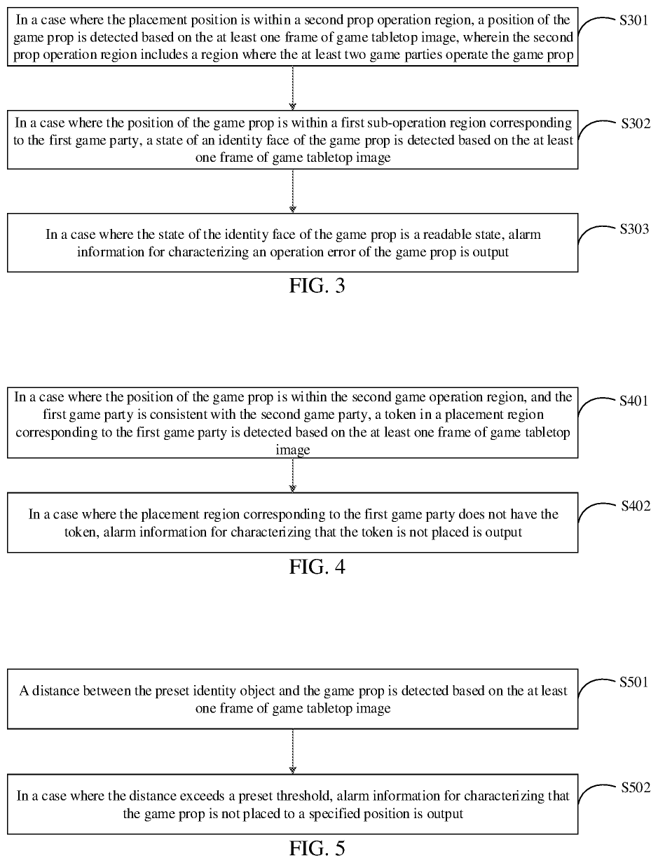

FIG. 3 illustrates a third flowchart schematic diagram of an alarm method for a tabletop game provided by an embodiment of the disclosure. As shown in FIG. 3, in the embodiment of the disclosure, the first prop operation region may include at least two first sub-operation regions in one-to-one correspondence with the at least two game parties, and the alarm apparatus may further execute the following steps.

In S301, in a case where the placement position is within a second prop operation region, a position of the game prop is detected based on the at least one frame of game tabletop image, wherein the second prop operation region includes a region where the at least two game parties operate the game prop.

In S302, in a case where the position of the game prop is within a first sub-operation region corresponding to the first game party, a state of an identity face of the game prop is detected based on the at least one frame of game tabletop image.

In S303, in a case where the state of the identity face of the game prop is a readable state, alarm information for characterizing an operation error of the game prop is output.

It is to be noted that, in the embodiment of the disclosure, the game prop may have two opposite faces. One face of the game prop is recorded with information, and in a case where the face recorded with the information is displayed, the state of the identity face of the game prop is the readable state; and the other face of the game prop is not recorded with the information, and in a case where the face not recorded with the information is displayed, the state of the identity face of the game prop is an unreadable state.

It is to be noted that, in the embodiment of the disclosure, the tabletop of the game not only includes the first prop operation region, and but also includes the second prop operation region where the at least two game parties operate the game prop. If determining that the placement position of the preset identity object is within the second prop operation region, the alarm apparatus characterizes that a process of enabling the game party to operate the game prop is entered at present. By this time, the alarm apparatus may detect a position and a state of the identity face of the game prop; if it is detected that the game prop is not provided for the first game party, i.e., in a case where the game prop is within the first sub-operation region corresponding to the first game party, by this time, the game prop cannot be operated actually, i.e., the state of the identity face of the game prop needs to be the unreadable state, and if it is detected that the state of the identity face of the game prop is the readable state, the alarm information for characterizing the operation error of the game prop is output to prompt the game controller of making corrections.

It is to be noted that, in the embodiment of the disclosure, after outputting the alarm information for characterizing the operation error of the game prop, the alarm apparatus may further execute the following step: in a case where it is detected that the game prop is recycled in an image after a fourth image in the at least one frame of game tabletop image, the alarm information for characterizing the operation error of the game prop is removed. The fourth image is an image where it is detected that the state of the identity face of the game prop is the readable state in the at least one frame of game tabletop image.

It is to be understood that, in the embodiment of the disclosure, in the at least one frame of game tabletop image, the image where the alarm apparatus detects that the state of the identity face of the game prop is the readable state is the fourth image. After the alarm apparatus outputs the alarm information for characterizing the operation error of the game prop, the game prop cannot be provided for the game party because it has been wrongly operated, and the game prop needs to be replaced. Therefore, the game controller may take away and recycle the game prop; and correspondingly, the alarm apparatus may detects that the game prop is recycled in the image after the fourth image, for example, detecting a preset take-away action that the game controller takes way the game prop, to remove the alarm information.

FIG. 4 illustrates a fourth flowchart schematic diagram of an alarm method for a tabletop game provided by an embodiment of the disclosure. As shown in FIG. 4, in the embodiment of the disclosure, in the case where the placement position of the preset identity object is within the second prop operation region, the alarm apparatus may further execute the following steps.

In S401, in a case where the position of the game prop is within the second game operation region, and the first game party is consistent with the second game party, a token in a placement region corresponding to the first game party is detected based on the at least one frame of game tabletop image.

In S402, in a case where the placement region corresponding to the first game party does not have the token, alarm information for characterizing that the token is not placed is output.

It is to be noted that, in the embodiment of the disclosure, the game not only involves the preset identity object and the game prop, but also involves the token provided by the game party, configured to participate in the game. The tokens provided by different game parties need to be placed in corresponding placement regions.

It is to be noted that, in the embodiment of the disclosure, in the case where the placement position of the preset identity object is within the second game operation region, the preset identity object is placed correctly, i.e., the first game party is consistent with the second game party, and the game prop is placed correctly, i.e., the game prop is within the second prop operation region, the alarm apparatus may further detect whether the placement region corresponding to the first game party has the token; and if the placement region does not have the token, the first game party does not normally participate in the game, and thus the alarm information for characterizing that the token is not placed is output.

It is to be noted that, in the embodiment of the disclosure, after outputting the alarm information for characterizing that the token is not placed, the alarm apparatus may further execute the following step: in a case where it is detected that the placement region corresponding to the first game party has the token in an image after a fifth image in the at least one frame of game tabletop image, the alarm information for characterizing that the token is not placed is removed. The fifth image is an image that the token is not detected in the placement region corresponding to the first game party in the at least one frame of game tabletop image.

It is to be understood that, in the embodiment of the disclosure, in the at least one frame of game tabletop image, the image where the alarm apparatus does not detect the token in the placement region corresponding to the first game party is the fifth image. After the alarm apparatus outputs the alarm information for characterizing that the token is not placed, the first game party may provide the token, and place the token to the placement region corresponding to the first game party; and correspondingly, the alarm apparatus may detect that the placement region corresponding to the first game party has the token in the image after the fifth image, to remove the alarm information.

FIG. 5 illustrates a fifth flowchart schematic diagram of an alarm method for a tabletop game provided by an embodiment of the disclosure. As shown in FIG. 5, in the embodiment of the disclosure, i.e., both the placement position of the preset identity object and the position of the game prop are within the second prop operation region, the alarm apparatus may further execute the following steps.

In S501, a distance between the preset identity object and the game prop is detected based on the at least one frame of game tabletop image.

In S502, in a case where the distance exceeds a preset threshold, alarm information for characterizing that the game prop is not placed to a specified position is output.

It is to be noted that, in the embodiment of the disclosure, the preset identity object actually indicates the placement position of the game prop, and the game prop needs to be placed around the preset identity object. When both the placement position of the preset identity object and the position of the game prop are within the second prop operation region, the game controller has allocated the game prop to the first game party based on the preset identity object to be operated by the first game party. However, the game controller may wrongly place the game prop at a position away from the preset identity object in the second prop operation region, for example, placing at a placement region corresponding to other game party. Therefore, the alarm apparatus may detect the distance between the preset identity object and the game prop. After detecting the distance between the preset identity object and the game prop, the alarm apparatus may compare the distance with a preset threshold; and if the distance exceeds the preset threshold, the game prop is not placed to the specified position, and the correspondingly alarm information is output, to prompt the game controller of adjusting the position of the game prop, thereby improving the accuracy of placing the game prop.

It is to be noted that, in the embodiment of the disclosure, after outputting the alarm information for characterizing that the game prop is not placed to the specified position, the alarm apparatus may further execute the following step: in a case where it is detected that the distance does not exceed the preset threshold in an image after a sixth image in the at least one frame of game tabletop image, the alarm information for characterizing that the game prop is not placed to the specified position is removed. The sixth image is an image where it is detected that the distance exceeds the preset threshold in the at least one frame of game tabletop image.

It is to be understood that, in the embodiment of the disclosure, in the at least one frame of game tabletop image, the image where the alarm apparatus detects that the distance between the preset identity object and the game prop exceeds the preset threshold is the sixth image. After the alarm apparatus outputs the alarm information for characterizing that the game prop is not placed to the specified position, the game controller may push the game prop, such that the game prop gets close to the preset identity object; and correspondingly, the alarm apparatus may detect that the distance does not exceed the preset threshold in the image after the sixth image, to remove the alarm information.

It is to be noted that, in the embodiment of the disclosure, the alarm information may be text information, may also be image information, and may further be acoustic information, which is not limited in the embodiment of the disclosure.

The embodiment of the disclosure provides the alarm method for the tabletop game. The method includes that: at least one frame of game tabletop image collected in a prop operation stage of a game is acquired; for each frame in the at least one frame of game tabletop image, a placement position of a preset identity object in the game tabletop image is detected, a tabletop of the game including a placement region corresponding to each game party in at least two game parties, and the preset identity object being configured to identify a first game party allowed to operate a game prop; a second game party corresponding to the placement position of the preset identity object is determined according to the placement region corresponding to each game party; and in a case where the first game party is inconsistent with the second game party, alarm information for characterizing a placement error of the preset identity object is output. The alarm method provided by the embodiment of the disclosure detects whether a special object in the tabletop game is placed correctly, and outputs alarm information timely in a case of a placement error, thereby improving the accuracy of placing the special object in the tabletop game.

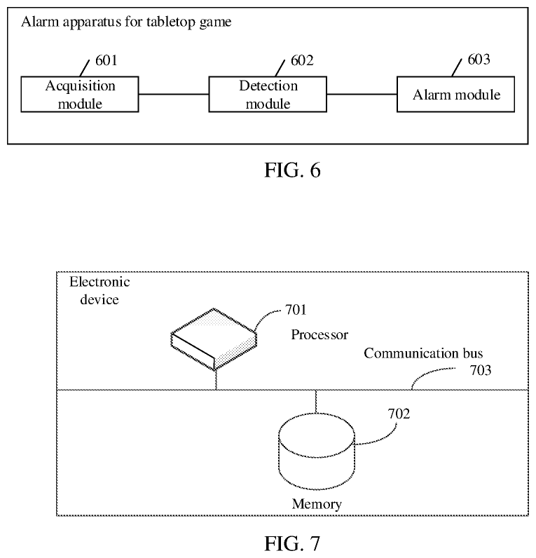

The embodiments of the disclosure provide an alarm apparatus for a tabletop game. FIG. 6 illustrates a structural schematic diagram of an alarm apparatus for a tabletop game provided by an embodiment of the disclosure. As shown in FIG. 6, the alarm apparatus may include: an acquisition module 601, a detection module 602 and an alarm module 603.

The acquisition module 601 is configured to acquire at least one frame of game tabletop image collected in a prop operation stage of a game.

The detection module 602 is configured to detect, for each frame in the at least one frame of game tabletop image, a placement position of a preset identity object in the game tabletop image, a tabletop of the game including a placement region corresponding to each game party in at least two game parties, and the preset identity object being configured to identify a first game party allowed to operate a game prop; and determine a second game party corresponding to the placement position of the preset identity object according to the placement region corresponding to each game party.

The alarm module 603 is configured to output, in a case where the first game party is inconsistent with the second game party, alarm information for characterizing a placement error of the preset identity object.

In an embodiment of the disclosure, the detection module 602 is specifically configured to determine, in a case where the placement position is not within a first prop operation region, the second game party corresponding to the placement position of the preset identity object according to the placement region corresponding to each game party, wherein the first prop operation region comprises a region where a game controller operates a game prop.

In an embodiment of the disclosure, the alarm module 603 is further configured to remove, in a case where the detection module 602 detects that the first game party is consistent with the second game party in an image after a first image in the at least one frame of game tabletop image, the alarm information for characterizing the placement error of the preset identity object.

The first image is an image where it is detected that the first game party is inconsistent with the second game party in the at least one frame of game tabletop image.

In an embodiment of the disclosure, the detection module 602 is further configured to detect, in a case where the placement position is within the first prop operation region, a position of the game prop based on the at least one frame of game tabletop image.

The alarm module 603 is further configured to output, in response to that the position of the game prop is not within the first prop operation region, alarm information for characterizing an operation error of the game prop.

In an embodiment of the disclosure, the alarm module 603 is further configured to remove, in a case where the detection module 602 detects that the position of the game prop is within the first prop operation region in an image after a second image in the at least one frame of game tabletop image, the alarm information for characterizing the operation error of the game prop.

The second image is an image where it is detected that the position of the game prop is not within the first prop operation region in the at least one frame of game tabletop image.

In an embodiment of the disclosure, the first prop operation region may include at least two first sub-operation regions in one-to-one correspondence with the at least two game parties, and the method may further include the following operation.

The alarm module 603 is further configured to output, in a case where a first sub-operation region where the placement position is located does not have the game prop, alarm information for characterizing an operation error of a game prop of a target game party, the target game party being a game party corresponding to the first sub-operation region where the placement position is located.

In an embodiment of the disclosure, the alarm module 603 is further configured to remove, in a case where the detection module 602 detects that the first sub-operation region where the placement position is located has the game prop in an image after a third image in the at least one frame of game tabletop image, the alarm information for characterizing the operation error of the game prop of the target game party.

The third image is an image where it is detected that the first sub-operation region where the placement position is located does not have the game prop in the at least one frame of game tabletop image.

In an embodiment of the disclosure, the detection module 602 is further configured to detect, in a case where the placement position is within a second prop operation region, a position of the game prop based on the at least one frame of game tabletop image, wherein the second prop operation region may include a region where the at least two game parties operate the game prop; and detect, in a case where the position of the game prop is within a first sub-operation region corresponding to the first game party in the first prop operation region, a state of an identity face of the game prop based on the at least one frame of game tabletop image.

The alarm module 603 is further configured to output, in a case where the state of the identity face of the game prop is a readable state, alarm information for characterizing an operation error of the game prop.

In an embodiment of the disclosure, the alarm module 603 is further configured to remove, in a case where the detection module 602 detects that the game prop is recycled in an image after a fourth image in the at least one frame of game tabletop image, the alarm information for characterizing the operation error of the game prop.

The fourth image is an image where it is detected that the state of the identity face of the game prop is the readable state in the at least one frame of game tabletop image.

In an embodiment of the disclosure, the detection module 602 is further configured to detect, in a case where the position of the game prop is within the second game operation region, and the first game party is consistent with the second game party, a token in a placement region corresponding to the first game party based on the at least one frame of game tabletop image.

The alarm module 603 is further configured to output, in a case where the placement region corresponding to the first game party does not have the token, alarm information for characterizing that the token is not placed.

In an embodiment of the disclosure, the alarm module 603 is further configured to remove, in a case where the detection module 602 detects that the placement region corresponding to the first game party has the token in an image after a fifth image in the at least one frame of game tabletop image, the alarm information for characterizing that the token is not placed.

The fifth image is an image that the token is not detected in the placement region corresponding to the first game party in the at least one frame of game tabletop image.

In an embodiment of the disclosure, the detection module 602 is further configured to detect a distance between the preset identity object and the game prop based on the at least one frame of game tabletop image.

The alarm module 603 is further configured to output, in a case where the distance exceeds a preset threshold, alarm information for characterizing that the game prop is not placed to a specified position.

In an embodiment of the disclosure, the alarm module 603 is further configured to remove, in a case where the detection module 602 detects that the distance does not exceed the preset threshold in an image after a sixth image in the at least one frame of game tabletop image, the alarm information for characterizing that the game prop is not placed to the specified position.

The sixth image is an image where it is detected that the distance exceeds the preset threshold in the at least one frame of game tabletop image.

The embodiments of the disclosure provide an electronic device. FIG. 7 illustrates a structural schematic diagram of an electronic device provided by an embodiment of the disclosure. As shown in FIG. 7, the electronic device may include: a processor 701, a memory 702 and a communication bus 703.

The communication bus 703 is configured to implement connection and communication between the processor 701 and the memory 702.

The processor 701 is configured to execute one or more programs stored in the memory 702, to implement the alarm method for the tabletop game.

The embodiments of the disclosure provide a computer-readable storage medium, which stores one or more programs; and the one or more programs may be executed by one or more processors, to implement the alarm method for the tabletop game. The computer readable storage may be a volatile memory such as a Random-Access Memory (RAM), or a non-volatile memory such as a Read-Only Memory (ROM), a flash memory, a Hard Disk Drive (HDD) or a Solid-State Drive (SSD), or may also be a device including any one or combination of the above memories, such as a mobile phone, a computer, a tablet and a PDA.

Those skilled in the art should understand that the embodiments of the disclosure can provide a method, a system or a computer program product. Thus, forms of hardware embodiments, software embodiments or embodiments integrating software and hardware can be adopted in the disclosure. Moreover, a form of the computer program product implemented on one or more computer available storage media (including, but not limited to, a disk memory, an optical memory and the like) containing computer available program codes can be adopted in the disclosure.

The disclosure is described with reference to flowcharts and/or block diagrams of the method, the device (system) and the computer program product according to the embodiments of the disclosure. It should be understood that each flow and/or block in the flowcharts and/or the block diagrams and a combination of the flows and/or the blocks in the flowcharts and/or the block diagrams can be realized by computer program instructions. These computer program instructions can be provided for a general computer, a dedicated computer, an embedded processor or processors of other programmable data processing devices to generate a machine, so that an apparatus for realizing functions assigned in one or more flows of the flowcharts and/or one or more blocks of the block diagrams is generated via instructions executed by the computers or the processors of the other programmable data processing devices.

These computer program instructions can also be stored in a computer readable memory capable of guiding the computers or the other programmable data processing devices to work in a specific mode, so that a manufactured product including an instruction apparatus is generated via the instructions stored in the computer readable memory, and the instruction apparatus realizes the functions assigned in one or more flows of the flowcharts and/or one or more blocks of the block diagrams.

These computer program instructions can also be loaded to the computers or the other programmable data processing devices, so that processing realized by the computers is generated by executing a series of operation steps on the computers or the other programmable devices, and therefore the instructions executed on the computers or the other programmable devices provide a step of realizing the functions assigned in one or more flows of the flowcharts and/or one or more blocks of the block diagrams.

The above are merely preferred embodiments of the disclosure, rather than a limit to the protection scope of the disclosure.

1. An alarm method for a tabletop game, comprising:
acquiring at least one frame of game tabletop image collected in a prop operation stage of a game;
detecting, for each frame in the at least one frame of game tabletop image, a placement position of a preset identity object in the game tabletop image, a tabletop of the game comprising a placement region corresponding to each game party in at least two game parties, and the preset identity object being configured to identify a first game party allowed to operate a game prop;
determining a second game party corresponding to the placement position of the preset identity object according to the placement region corresponding to the each game party; and
outputting, in a case where the first game party is inconsistent with the second game party, alarm information for characterizing a placement error of the preset identity object.

2. The method of claim 1, wherein determining the second game party corresponding to the placement position of the preset identity object according to the placement region corresponding to the each game party comprises:
determining, in a case where the placement position is not within a first prop operation region, the second game party corresponding to the placement position of the preset identity object according to the placement region corresponding to the each game party,
wherein the first prop operation region comprises a region where a game controller operates a game prop.

3. The method of claim 1, wherein after outputting the alarm information for characterizing the placement error of the preset identity object, the method further comprises:
removing, in a case of detecting that the first game party is consistent with the second game party in an image after a first image in the at least one frame of game tabletop image, the alarm information for characterizing the placement error of the preset identity object,
wherein the first image is an image of detecting that the first game party is inconsistent with the second game party in the at least one frame of game tabletop image.

4. The method of claim 2, wherein the method further comprises:
detecting, in a case where the placement position is within the first prop operation region, a position of the game prop based on the at least one frame of game tabletop image; and
outputting, in response to that the position of the game prop is not within the first prop operation region, alarm information for characterizing an operation error of the game prop.

5. The method of claim 4, wherein after outputting the alarm information for characterizing the operation error of the game prop, the method further comprises:
removing, in a case of detecting that the position of the game prop is within the first prop operation region in an image after a second image in the at least one frame of game tabletop image, the alarm information for characterizing the operation error of the game prop,
wherein the second image is an image of detecting that the position of the game prop is not within the first prop operation region in the at least one frame of game tabletop image.

6. The method of claim 4, wherein the first prop operation region comprises at least two first sub-operation regions in one-to-one correspondence with the at least two game parties, and the method further comprises:
outputting, in a case where a first sub-operation region where the placement position is located does not have the game prop, alarm information for characterizing an operation error of a game prop of a target game party, the target game party being a game party corresponding to the first sub-operation region where the placement position is located.

7. The method of claim 6, wherein after outputting the alarm information for characterizing the operation error of the game prop of the target game party, the method further comprises:
removing, in a case of detecting that the first sub-operation region where the placement position is located has the game prop in an image after a third image in the at least one frame of game tabletop image, the alarm information for characterizing the operation error of the game prop of the target game party,
wherein the third image is an image of detecting that the first sub-operation region where the placement position is located does not have the game prop in the at least one frame of game tabletop image.

8. The method of claim 2, wherein the first prop operation region comprises at least two first sub-operation regions in one-to-one correspondence with the at least two game parties, and the method further comprises:
detecting, in a case where the placement position is within a second prop operation region, a position of the game prop based on the at least one frame of game tabletop image, wherein the second prop operation region comprises a region where the at least two game parties operate the game prop;
detecting, in a case where the position of the game prop is within a first sub-operation region corresponding to the first game party, a state of an identity face of the game prop based on the at least one frame of game tabletop image; and
outputting, in a case where the state of the identity face of the game prop is a readable state, alarm information for characterizing an operation error of the game prop.

9. The method of claim 8, wherein after outputting the alarm information for characterizing the operation error of the game prop, the method further comprises:
removing, in a case of detecting that the game prop is recycled in an image after a fourth image in the at least one frame of game tabletop image, the alarm information for characterizing the operation error of the game prop,
wherein the fourth image is an image of detecting that the state of the identity face of the game prop is the readable state in the at least one frame of game tabletop image.

10. The method of claim 8, wherein the method further comprises:
detecting, in a case where the position of the game prop is within the second prop operation region, and the first game party is consistent with the second game party, a token in a placement region corresponding to the first game party based on the at least one frame of game tabletop image; and
outputting, in a case where the placement region corresponding to the first game party does not have the token, alarm information for characterizing that the token is not placed.

11. The method of claim 10, wherein after outputting the alarm information for characterizing that the token is not placed, the method further comprises:
removing, in a case of detecting that the placement region corresponding to the first game party has the token in an image after a fifth image in the at least one frame of game tabletop image, the alarm information for characterizing that the token is not placed,
wherein the fifth image is an image that the token is not detected in the placement region corresponding to the first game party in the at least one frame of game tabletop image.

12. The method of claim 10, wherein the method further comprises:
detecting a distance between the preset identity object and the game prop based on the at least one frame of game tabletop image; and
outputting, in a case where the distance exceeds a preset threshold, alarm information for characterizing that the game prop is not placed to a specified position.

13. The method of claim 12, wherein after outputting the alarm information for characterizing that the game prop is not placed to the specified position, the method further comprises:
removing, in a case of detecting that the distance does not exceed the preset threshold in an image after a sixth image in the at least one frame of game tabletop image, the alarm information for characterizing that the game prop is not placed to the specified position,
wherein the sixth image is an image of detecting that the distance exceeds the preset threshold in the at least one frame of game tabletop image.

14. An electronic device, comprising a processor, a memory and a communication bus, wherein
the communication bus is configured to implement connection and communication between the processor and the memory; and
the processor is configured to execute one or more programs stored in the memory, to implement an alarm method for a tabletop game, the method comprising:
acquiring at least one frame of game tabletop image collected in a prop operation stage of a game;
detecting, for each frame in the at least one frame of game tabletop image, a placement position of a preset identity object in the game tabletop image, a tabletop of the game comprising a placement region corresponding to each game party in at least two game parties, and the preset identity object being configured to identify a first game party allowed to operate a game prop;
determining a second game party corresponding to the placement position of the preset identity object according to the placement region corresponding to the each game party; and
outputting, in a case where the first game party is inconsistent with the second game party, alarm information for characterizing a placement error of the preset identity object.

15. A nonvolatile computer-readable storage medium, storing one or more programs, wherein the one or more programs are able to be executed by one or more processors, to implement an alarm method for a tabletop game, the method comprising:
acquiring at least one frame of game tabletop image collected in a prop operation stage of a game;
detecting, for each frame in the at least one frame of game tabletop image, a placement position of a preset identity object in the game tabletop image, a tabletop of the game comprising a placement region corresponding to each game party in at least two game parties, and the preset identity object being configured to identify a first game party allowed to operate a game prop;
determining a second game party corresponding to the placement position of the preset identity object according to the placement region corresponding to the each game party; and outputting, in a case where the first game party is inconsistent with the second game party, alarm information for characterizing a placement error of the preset identity object.
